(19) United States
(12) Patent Application Publication
(10) Pub. No.: US 2013/0023307 A1
(43) Pub. Date: Jan. 24, 2013

(54) MICROPROJECTION ELEMENTS FOR PORTABLE DEVICES

(71) Applicants: Scott M. Zimmerman, Basking Ridge, NJ (US); William R. Livesay, San Diego, CA (US); Richard L. Ross, Del Mar, CA (US)

(72) Inventors: Scott M. Zimmerman, Basking Ridge, NJ (US); William R. Livesay, San Diego, CA (US); Richard L. Ross, Del Mar, CA (US)

(21) Appl. No.: 13/555,067

(22) Filed: Jul. 20, 2012

Related U.S. Application Data
(60) Provisional application No. 61/572,769, filed on Jul. 21, 2011.

(51) Int. Cl. H04W 88/02; G03B 21/28

(52) U.S. Cl. 455/557; 353/99

(57) ABSTRACT

Additional power and cooling can be provided for microprojectors by supplemental rechargeable power sources that can be integrated into memory sticks or by expansion cards that can plug into cellphones, PDAs and other portable devices. A docking station for portable devices using microprojectors contains supplemental power, cooling means, addition data/audio/video interfaces, touch screen/optical interface, projection optics, contrast enhancing screens and/or addition optics for video conferencing. Optics can be adapted to the microprojector for better imaging, secured communications, enhanced light sources, low versus high power operation ratios, and contrast enhancing screens.

### REFERENCE TO PRIOR APPLICATION

This application claims the benefit of U.S. Provisional Patent Application Ser. No. 61/572,769, which was filed on Jul. 21, 2011, which is herein incorporated by reference.

### BACKGROUND OF THE INVENTION

Portable devices are becoming continually more sophisticated and important to everyday life. Cell phones and internet-based phone links have become the preferred form of communication, especially in developing countries. Weight, size, and battery life are key design constraints in any of these devices. This, however, runs counter to usage with regard to the human interface. Key spacing, display size, and battery volume are all limited in existing portable devices. This patent relates to accessories and devices, which enhance the usability of portable devices, especially with regard to embedded micro-projectors.

Microprojectors are presently being introduced into portable devices based on LCOS, transmissive LCD, DLP and MEMS based modulators. In most cases LEDs are used for light sources, however laser diodes are included as well if the laser diodes overcome safety, speckle, life and cost issues. The authors have previously disclosed the use of light recycling cavities to create compact, low cost, small etendue light RGB sources for these applications. These sources are typically used in color sequential applications and eliminate the need for dichroic combiners and other combining means, which increases volume and is suspectible to misalignment due to shock. These projectors exhibit just a few cubic centimeters of volume and typically draw about 1 watt of electrical power.

The need however exists for devices, which improve the performance and usability of microprojectors with regard to battery life, viewability, and heat dissipation. A wide range of ambient conditions are possible because these devices are portable. Not one operating conditions is appropriate for all uses since contrast and viewability are a function of the ambient lighting conditions. Contrast enhancing means are used such as portable projection screens, which take advantage of the polarized output of LCOS, LCD and some laser diode projectors. In addition, the use of short throw or reflective optics oblique projection screens can be constructed which further enhance contrast. The need also exists for 3 D viewing options as well as interfaces to secure viewing via near eye and restricted viewing screens.

As disclosed in Harris Pat. 7,782,613 supplemental cooling for portable devices can increase operation times. In Harris, a temperature activated fan provides cooling. This reduces life, is bulky, and can be noisy. A more compact cooling method is needed.

Also disclosed by King Pat. 8,081,849 are portable scanners with integrated memory have been disclosed for capturing and transmitting data and images. Imaging via microprojectors is not disclosed.

In most cases, LEDs are operated in sequential mode at significantly reduced average current levels. This allows for higher output level conditions as long as supplemental power and cooling means are provided. The need therefore exists for supplementary power and cooling means, which can enable microprojectors different levels of operation depending on whether the device is handheld or docked. In these docked applications, the ability to use the portable device as video link is also needed. This would enable presentations but also video conferencing capability in remote locations. In addition, the need exists for new optical elements, which can further reduce package size and improve both the contrast and color gamut of the microprojector while maintaining low power consumption.

### SUMMARY OF THE INVENTION

As microprojectors continue to expand in popularity the need exists for enhanced performance and new features. This intent of this invention is to disclose accessories and enhancements to microprojectors, which improve usability, viewability, and reliability. Supplemental rechargeable power sources can be integrated into memory sticks such that both additional power and cooling can be provided appropriate for the presentation, video, or other application requirements. In this manner, a wide range of capability can be added to a basic projector device ranging from a simple presentation to full video conferencing. Expansion cards can plug into cellphones, PDAs and other portable devices containing microprojectors which supplement power, memory, provide additional interfaces, and/or provide cooling means.

A docking station for portable devices containing microprojectors contains supplemental power, cooling means, addition data/audio/video interfaces, touch screen/optical interface, projection optics, contrast enhancing screens and/or addition optics for video conferencing.

Optics can be adapted to image coherent fiber bundles and used in near eye applications for both portability and privacy reasons. Wireless as well as hardwire interconnect between tandem portable devices enable gaming and 3d imaging. Even more preferred is the use of tandem polarized microprojector devices which enable both 3d imaging and secure viewing applications. Secure communications based on polarized, image encoding, sequential encoding as well as other methods in which the multiple microprojectors must be superimposed together to form the complete image or desired information is disclosed.

Enhanced light sources via internal dichroic coatings, polarization coatings, and stacked LED chips increase efficiency and/or allow for improved low versus high power operation ratios. The use of these cavities with ¼ hemisphere solid collimation optics allows for improved color mixing, improved polarization recovery optics, single substrate device designs and reduced package size. Reflective projection optics allow for short throw and oblique angle projection. A microprojector can be based on an active matrix address white led array, color sequential shutter, and projection lens.

A contrast enhancing screen can be integrated within a notebook. In addition, a positioning element may be integrated into the standard notebook which allows for control of orientation of the microprojector to the contrast enhancement screen such that polarization and/or oblique angle contrast enhancements can be taken advantage of. In a preferred embodiment, the notebook would include at least one of the following: contrast enhancing screen, alignment element, cooling means, audio input and output, supplemental power source, memory storage, and/or shrouding means for secure viewing. Alternately, these elements can be incorporated into briefcases, clipboards, and cylindrical objects including, but not limited to, pens and walking sticks in which retractable flexible screens could be stored. A preferred embodiment is the incorporation of a microprojector into a pager for emergency services such that data regarding an incident scene can be viewed. In another embodiment a contrast enhancement screen can be combined with a film based speaker.

The incorporation of stabilization means to the optical path of the microprojector is disclosed. Several projector/video camera combinations also take advantage of the polarized output of the projection system. Polarization recycling techniques can enhance contrast for LCOS and LCD microprojectors. A combination LED and laser diode light source has the laser diode light source coupled into the LED itself for the purpose of creating a more uniform source and reducing speckle. A preferred embodiment of this approach is based on the freestanding epitaxial chips or stacks of freestanding epitaxial chips previously disclosed by the authors. Several configurations of light sources with integrated pyrolytic graphite films are disclosed.

A microprojector can be incorporated into a key for a car and/or home. A preferred embodiment is the incorporation of a micro projector into a proximity car key allowing for usage by other passengers while driving.

In general, this invention discloses accessories, methods and designs, which enhance contrast, extend projector brightness, combine projectors, and enhance security for users of microprojectors. In addition, improved microprojector designs are also disclosed.

### BRIEF DESCRIPTION OF THE DRAWINGS

FIG. 1 depicts a perspective view of a cellphone with a microprojector of the present invention.

FIG. 2 depicts a perspective view of a memory stick attachment with supplemental rechargeable power source of the present invention.

FIGS. 3A and 3B depict a side view of a docking station with contrast enhancing screen of the present invention.

FIG. 4 depicts a side view of an image coherent fiber adapter for a cellphone of the present invention.

FIG. 5 depicts a side view of tandem cellphone projectors of the present invention.

FIG. 6 depicts a side view of microprojectors in security applications of the present invention.

FIG. 7 depicts a side view of an enhanced cavity with dichroic coated LEDs of the present invention.

FIG. 8 depicts a side view of an enhanced cavity using at least one stacked LEDs of the present invention.

FIGS. 9A and 9B depict a side view of a ¼ hemisphere lens of the present invention.

FIGS. 10A, 10B and 10C depict a side view of a compact projector design based on cavity, plus ¼ lens, plus reflective optics of the present invention.

FIGS. 11A and 11b depict a perspective view of a notebook with integral high contrast screen cellphone mount and supplemental power, cooling, and memory storage of the present invention.

FIG. 12 depicts a side view of stabilization optics for hand held projectors of the present invention.

FIG. 13 depicts a side view of a cellphone projector plus feedback touch screen, eye movement detector, laser pointer, interactive mouse of the present invention.

FIG. 14 depicts a side view of a cavity with integrated heatspreading element of the present invention.

FIG. 15 depicts a side view of nitride based LED array for microprojector applications of the present invention.

FIG. 16 depicts a side view of a cellphone docking station with reflective optics, oblique angle screen, cooling plate, charging of the present invention.

FIG. 17 depicts a side view of a projection Security Device integrated into key chain of the present invention.

FIG. 18 depicts a side view of a combination LED and laser diode light source for micro projection of the present invention.

### DETAILED DESCRIPTION OF THE INVENTION

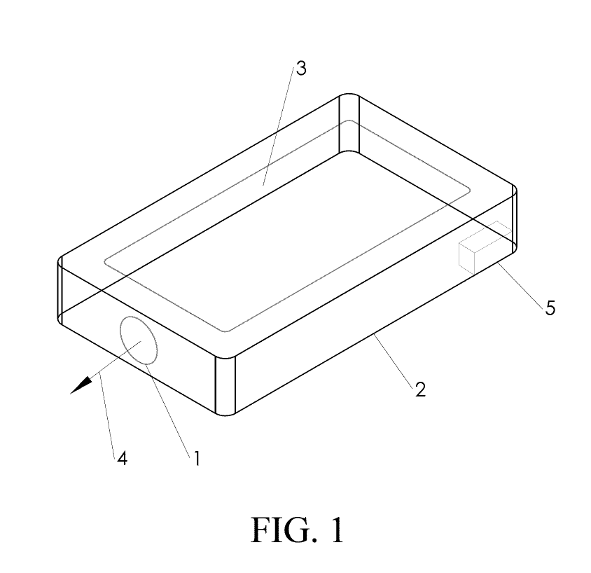

FIG. 1 depicts a cellphone 2 with an embedded microprojector 1. Rechargeable battery source 5 and human interface 3 may include, but are not limited to, touch screen, keyboard and voice activated interface. The output image 4 maybe be polarized or unpolarized as it exits microprojector 1.

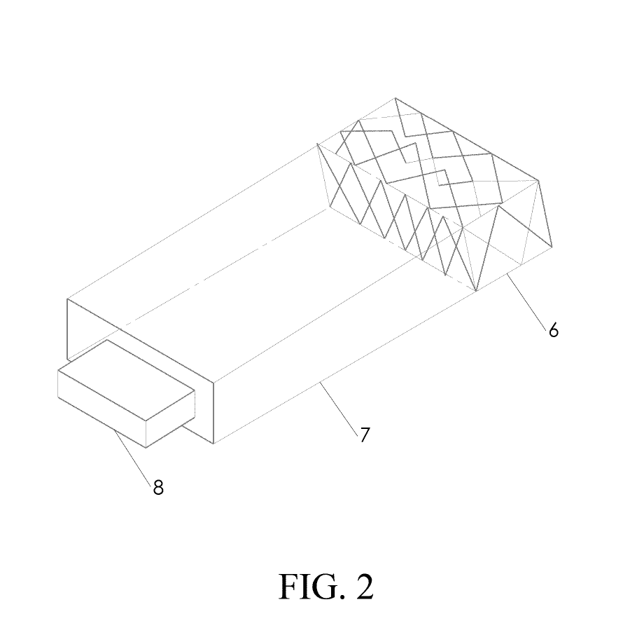

FIG. 2 depicts a memory stick attachment 7 with supplemental rechargeable power source 6. In many cases microprojectors can be operated in enhanced output mode if sufficient power and cooling are provided. The addition of a supplemental rechargeable power source 6 to a memory stick 7 is an embodiment of this invention. Connector 8 may be used to provide both memory functions as well as supplemental power. Single or multiple interconnects are embodiments of this invention as well the use of these interconnects to transfer heat from the microprojector into the memory stick attachment 7 where it is possible to takes advantage of the increased surface area of the memory stick attachment 7 to dissipate heat to the ambient.

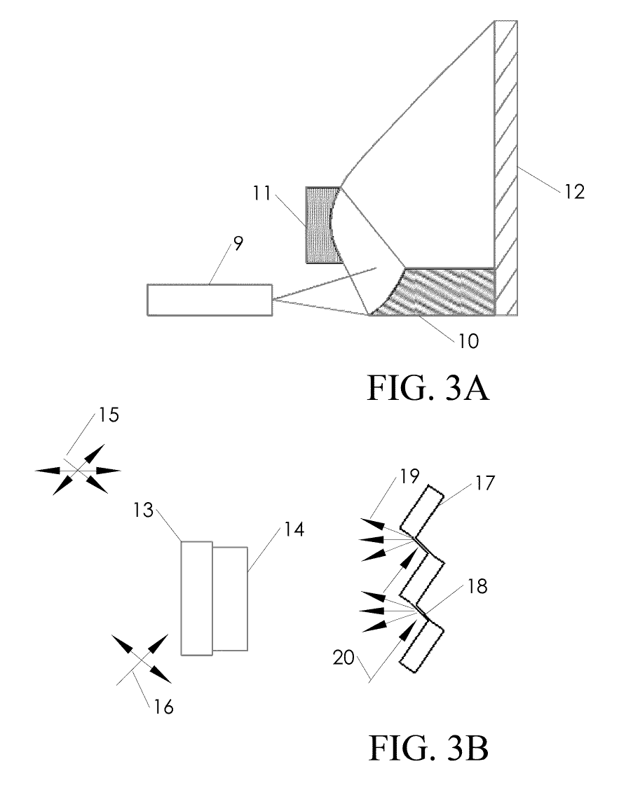

FIG. 3A depicts a docking station with a contrast enhancing screen 12. Microprojector 9 may be in a cellphone, pager, PDA or other mobile device. Reflective optics 10 and 11 allow for expansion of the image onto contrast enhancing screen 12. While the use of imaging or direct projection of the microprojector 9 output is included, the use of short throw optics enables contrast enhancement and compact projection viewing. More preferably, the use of polarization contrast enhancement and oblique angle contrast enhancement as depicted in FIG. 3B is disclosed. In the case of polarized output (linear or circular), projected light 16 can be oriented to polarized film 13 and reflective layer 14 such that high reflectivity is achieved. Conversely, ambient light 15 is unpolarized and will be partially absorbed by the polarized film 13 and not experience the same reflectivity from the reflective layer 14 as projected light 16. In this way contrast can be enhanced. Also depicted in FIG. 3B is the use of an oblique angle screen in which absorber 17 and reflector 18 are preferentially oriented to absorb ambient lighting which is predominately radiating downward and preferentially reflect projected light 20 which is directed upward. Diffusive elements based on scatter, microoptics, and subwavelength elements can be used to convert highly collimated projected light 20 into a desired output distribution 19 off of reflector 18.

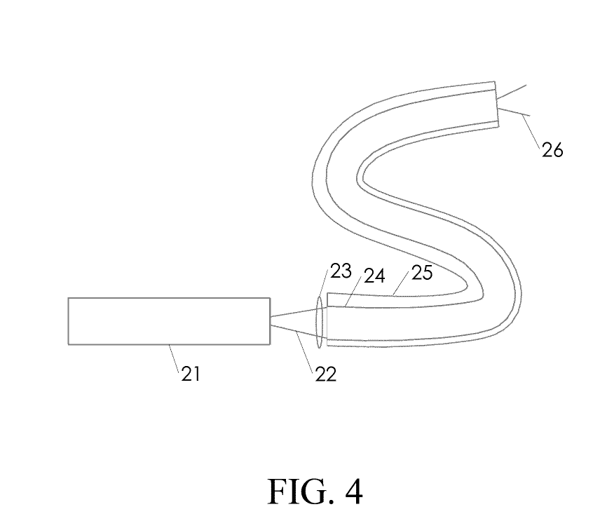

FIG. 4 depicts an image coherent fiber adapter connected to microprojector 21. The output 22 of the microprojector 22 is coupled either directly or via a relay lens 23 into image coherent bundle 24. Image coherent bundle 24 may consist of an array of optical fibers and/or grin type optical elements. Outer sheath 25 provides both protection and containment of the image coherent bundle 24. Output image 26 may be coupled to additional optics including, transmissive and reflective projection optics, near eye optics, and combiners, which allow for multiple projection sources to be merged.

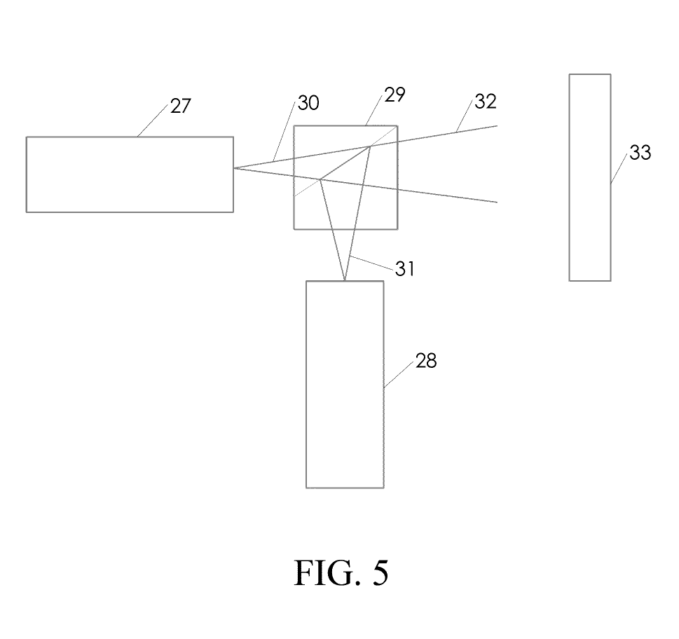

FIG. 5 depicts tandem cellphone projectors 27 and 28, which are combined via polarized beam splitter 29. In this case LCOS, LCD or other polarized microprojectors are preferred, however, a polarization filter can be added to an unpolarized microprojector. In the case of linearly polarized outputs 31 and 30, the outputs are oriented such that they are combined in polarized beam splitter 29. In this manner output 32 is the summation of the linear polarized outputs 31 and 30. Output 32 can impinge on screen 33 or be coupled into additional optical elements for subsequent imaging or coupling to near eye images. By properly sequencing linearly polarized outputs 31 and 30 along with viewing glasses, both passive and active 3D images can be produced for gaming, design and/or entertainment. This approach creates secure communications.

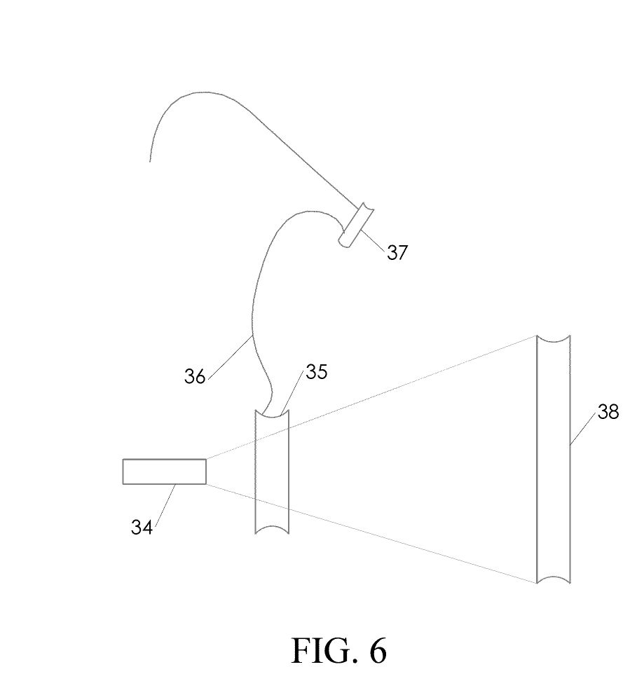

FIG. 6 depicts a microprojector 34 for secure viewing applications. Shutter 35 may consist of but not limited to spatial, temporal, phase, and/or spectral modulator which is coordinated via link 36 which may be electrical, optical or wireless in nature to viewer 37 which allows for viewing of the secure image on screen 38. Alternately screen 38 may incorporate the functionality of shutter 35 and be connected to viewer 37 via link 36 or some combination of both depending on the level of security desired.

A method of obtaining high reflectivity and extraction efficiency for an LED is presented in U.S. Pat. No. 7,352,006, commonly assigned as the present application and herein incorporated by reference.

In a light recycling cavity as described in U.S. Pat. Nos. 6,869,206; 6,960,872; and 7,040,774; commonly assigned as the present patent application and herein incorporated by reference, the reflectivity of the LEDs plays a dominant role in the extraction efficiency and light output of the recycling optical cavity. In U.S. Pat. Nos. 7,025,464; 7,048,385; and 7,431,463; commonly assigned as the present patent application and herein incorporated by reference, recycling light cavities contain LEDs with different emitting wavelengths.

The preferred light source of this invention comprises at least one light-emitting diode (LED). Preferred LEDs are inorganic light-emitting diodes and organic light-emitting diodes (OLEDs) that both emit light and reflect light. More preferred LEDs are inorganic light-emitting diodes due to their higher light output brightness.

An LED may be any LED that both emits light and reflects light. Examples of LEDs that both emit and reflect light include inorganic light-emitting diodes and OLEDs.

For purposes of simplifying the figures, each LED is illustrated in an identical manner and each LED has two elements, an emitting layer that emits light and a reflecting layer that reflects light. Note that typical LEDs are normally constructed with more than two elements, but for the purposes of simplifying the figures, the additional elements are not shown. Some of the embodiments of this invention may contain two or more LEDs. Although each LED is illustrated in an identical manner, it is within the scope of this invention that multiple LEDs in an embodiment may not all be identical. For example, if an embodiment of this invention has a plurality of LEDs, it is within the scope of this invention that some of the LEDs may be inorganic light-emitting diodes and some of the LEDs may be OLEDs. As a further example of an illumination system having multiple LEDs, if an embodiment of this invention has a plurality of LEDs, it is also within the scope of this invention that some of the LEDs may emit different colors of light. Example LED colors include, but are not limited to, wavelengths in the infrared, visible and ultraviolet regions of the optical spectrum. For example, one or more of the LEDs in a light-recycling envelope may emit red light, one or more of the LEDs may emit green light and one or more of the LEDs may emit blue light. If an embodiment, for example, contains LEDs that emit red, green and blue light, then the red, green and blue colors may be emitted concurrently to produce a single composite output color such as white light.

Preferred LEDs have at least one reflecting layer that reflects light incident upon the LED. The reflecting layer of the LED may be either a specular reflector or a diffuse reflector. Typically, the reflecting layer is a specular reflector. Preferably the reflectivity of the reflecting layer of the LED is at least 50%. More preferably, the reflectivity is at least 70%. Most preferably, the reflectivity R.sub.S is at least 90%.

Each LED is illustrated with an emitting layer facing the interior of the recycling optical cavity and a reflecting layer positioned behind the emitting layer and adjacent to the inside surface of the recycling optical cavity. In this configuration, light can be emitted from all surfaces of the emitting layer that are not in contact with the reflecting layer. It is also within the scope of this invention that a second reflecting layer can be placed on a portion of the surface of the emitting layer facing the interior of the light-recycling envelope. In the latter example, light can be emitted from the surfaces of the emitting layer that do not contact either reflecting layer. A second reflecting layer is especially important for some types of LEDs that have an electrical connection on the top surface of the emitting layer since the second reflecting layer can improve the overall reflectivity of the LED.

The total light-emitting area of the light source is area A.sub.S. If there is more than one LED within a single light-recycling envelope, the total light-emitting area A.sub.S of the light source is the total light-emitting area of all the LEDs in the light-recycling envelope.

The recycling optical cavity of this invention is a light-reflecting element that at least partially encloses the light source. The recycling optical cavity may be any three-dimensional surface that encloses an interior volume. For example, the surface of the recycling optical cavity may be in the shape of a cube, a rectangular three-dimensional surface, a sphere, a spheroid, an ellipsoid, an arbitrary three-dimensional facetted surface or an arbitrary three-dimensional curved surface. Preferably the recycling optical cavity has length, width and height dimensions such that no one dimension differs from the other two dimensions by more than a factor of five. In addition, preferably the three-dimensional shape of the recycling optical cavity is a facetted surface with flat surface sides in order to facilitate the attachment of the LEDs to the inside surfaces of the cavity. In general, LEDs are usually flat and the manufacture of the recycling optical cavity will be easier if the surfaces to which the LEDs are attached are also flat. Preferable three-dimensional shapes have a cross-section that is a square, a rectangle, a taper or a polygon.

The recycling optical cavity reflects and recycles a portion of the light emitted by the light source back to the light source. Preferably the reflectivity R.sub.E of the inside surfaces of the light recycling optical cavity is at least 50%. More preferably, the reflectivity R.sub.E is at least 70%. Most preferably, the reflectivity R.sub.E is at least 90%. Ideally, the reflectivity R.sub.E should be as close to 100% as possible in order to maximize the efficiency and exiting luminance of the illumination system.

The recycling optical cavity may be fabricated from a bulk material that is intrinsically reflective. A bulk material that is intrinsically reflective may be a diffuse reflector or a specular reflector. Preferably a bulk material that is intrinsically reflective is a diffuse reflector. Diffuse reflectors reflect light rays in random directions and prevent reflected light from being trapped in cyclically repeating pathways. Specular reflectors reflect light rays such that the angle of reflection is equal to the angle of incidence.

Alternatively, if the recycling optical cavity is not fabricated from an intrinsically reflective material, the interior surfaces of the recycling optical cavity must be covered with a reflective coating. The reflective coating may be a specular reflector, a diffuse reflector or a diffuse reflector that is backed with a specular reflector. Diffuse reflectors typically need to be relatively thick (a few millimeters) in order to achieve high reflectivity. The thickness of a diffuse reflector needed to achieve high reflectivity can be reduced if a specular reflector is used as a backing to the diffuse reflector. Diffuse reflectors can be made that have very high reflectivity (for example, greater than 95% or greater than 98%).

Most specular reflective materials have reflectivity ranging from about 80% to about 98.5%.

The interior volume of the recycling optical cavity that is not occupied by the light source may be occupied by a vacuum, may be filled with a light transmitting gas or may be filled or partially filled with a light-transmitting solid. Any gas or solid that fills or partially fills recycling optical cavity should transmit light emitted by the light source.

The recycling optical cavity has a light-output aperture. The light source and recycling optical cavity direct at least a fraction of the light emitted by the light source out of the recycling optical cavity through the light output aperture as incoherent light having a maximum exiting luminance. The total light output aperture area is area A.sub.O. An output aperture may have any shape including, but not limited to, a square, a rectangle, a polygon, a circle, an ellipse, an arbitrary facetted shape or an arbitrary curved shape.

For simplicity in FIG. 4, the recycling optical cavity is assumed to have a cubical three-dimensional shape and a square cross-sectional shape. The shape is chosen for illustrative purposes and for ease of understanding of the descriptions. It should also be noted that the drawing is merely a representation of the structure; the actual and relative dimensions may be different.

As noted previously, the recycling optical cavity may be any three-dimensional surface that encloses an interior volume. For example, the surface of the recycling optical cavity may be in the shape of a cube, a rectangular three-dimensional surface, a sphere, a spheroid, an ellipsoid, a pyramid, an arbitrary three-dimensional facetted surface or an arbitrary three-dimensional curved surface. Preferably the three-dimensional shape of the recycling optical cavity is a facetted surface with flat sides in order to facilitate the attachment of LEDs to the inside surfaces of the cavity. The only requirement for the three-dimensional shape of the recycling optical cavity is that a fraction of any light emitted from an LED within the recycling optical cavity must also exit from the light output aperture of the recycling optical cavity within a finite number of reflections within the recycling optical cavity, i.e. there are no reflective dead spots within the recycling optical cavity where the light emitted from the LED will endlessly reflect without exiting the recycling optical cavity through the light-output aperture.

The cross-section of the recycling optical cavity may have any shape, both regular and irregular, depending on the shape of the three-dimensional surface. Other examples of possible cross-sectional shapes include a rectangle, a taper, a polygon, a circle, an ellipse, an arbitrary facetted shape or an arbitrary curved shape. Preferable cross-sectional shapes are a square, a rectangle or a polygon.

The inside surfaces of the recycling optical cavity, except for the area covered by the LEDs and the area occupied by the light-output aperture, are light reflecting surfaces. The reflecting surfaces recycle a portion of the light emitted by the light source back to the light source. In order to achieve high light reflectivity, the recycling optical cavity may be fabricated from a bulk material that is intrinsically reflective or the inside surfaces of the recycling optical cavity may be covered with a reflective coating. The bulk material or the reflective coating may be a specular reflector, a diffuse reflector or a diffuse reflector that is backed with a specular reflector Preferably the reflectivity R.sub.E of the inside surfaces of the recycling optical cavity that are not occupied by the LEDs and the light output aperture is at least 50%. More preferably, the reflectivity R.sub.E is at least 70%. Most preferably, the reflectivity R.sup.E is at least 90%. Ideally, the reflectivity R.sub.E should be as close to 100% as possible in order to maximize the efficiency and the maximum exiting luminance of the illumination system.

The square cross-sectional shape of the recycling optical cavity has a first side containing the light-output aperture, a second side, a third side and a fourth side. The first side is opposite and parallel to the third side. The second side is opposite and parallel to the fourth side. The first side and third side are perpendicular to the second side and fourth side. The four sides of the recycling optical cavity plus the two remaining sides (not shown in the cross-sectional view) of the six-sided cube form the interior of the recycling optical cavity.

The light source for recycling optical cavity are LEDs, which emits light of specified optical wavelengths. LEDs are positioned interior to the sides of the recycling optical cavity and may be any inorganic light-emitting diode or an OLED.

Each LED has a reflecting layer and an emitting layer. The reflecting layer is adjacent to and interior to the side of the recycling optical cavity while the emitting layer extends into the interior of the recycling optical cavity. The reflecting layer may be a specular reflector or a diffuse reflector. In a typical inorganic light-emitting diode, the reflecting layer, if present, is usually a specular reflector. The light reflectivity of reflecting layer of the LED is R.sub.S. If the reflectivity varies across the area of the reflecting layer, the reflectivity R.sub.S is defined as the average reflectivity of the reflecting layer. The reflectivity R.sub.S of reflecting layer is preferably at least 50%. More preferably, the reflectivity R.sub.S of reflecting layer is at least 70%. Most preferably, the reflectivity R.sub.S of reflecting layer is at least 90%. Ideally, the reflectivity R.sub.S should be as close to 100% as possible in order to maximize the efficiency and the maximum exiting luminance of the recycling optical cavity.

The total light-emitting area of the light source is area A.sub.S.

The light output aperture is in one side of the recycling optical cavity. A fraction of the light emitted from the light source and reflected by the recycling optical cavity exits the light-output aperture. As noted, the aperture may have any shape including, but not limited to, a square, a rectangle, a polygon, a circle, an ellipse, an arbitrary facetted shape or an arbitrary curved shape. The total light output aperture area is area A.sub.O.

In U.S. Pat. No. 8,197,102, commonly assigned as the present patent application and herein incorporated by reference, light recycling cavities can be fabricated wherein the cavity is in a planar form with metallic hinges.

However, in a mixed red, green, and blue cavity it is possible to achieve even higher reflectivity for alternate wavelengths of each LED. By over-coating each LED with a multi-layer thin film coating comprising a dichroic filter, coatings can be applied so as to transmit the light emitted by the LED and reflect the light emanating from the other colors within the cavity. For example, with a recycling optical cavity comprising a red, green and blue LED, the red LED is coated with a long pass filter. This filter is optimally fully transparent for the red light emitted by the red LED and highly reflective of the light emitted by the blue and green LEDs. Similarly, the blue LED is coated with a short wave pass filter, which is transparent to the light emitted by the blue LED and highly reflective to the light emitted by the green and red LEDs. The green LED is coated with a narrow band pass filter, which is transparent to the light emitted by the green LED and is highly reflective to the light emitted by the blue and red LEDs. By utilizing high efficiency dichroic coatings, the reflectivity of the LEDs to the alternate wavelengths of the light emitted by other LEDs in the cavity can be raised to over 90%. This is significant because, for example, as mentioned previously, the red LED has very poor reflectivity (1 to 15%) for blue and green wavelengths. By raising the reflectivity for alternate wavelengths, the cavity efficiency can be raised from 50% in one case to over 80%, an increase of 60% in light output.

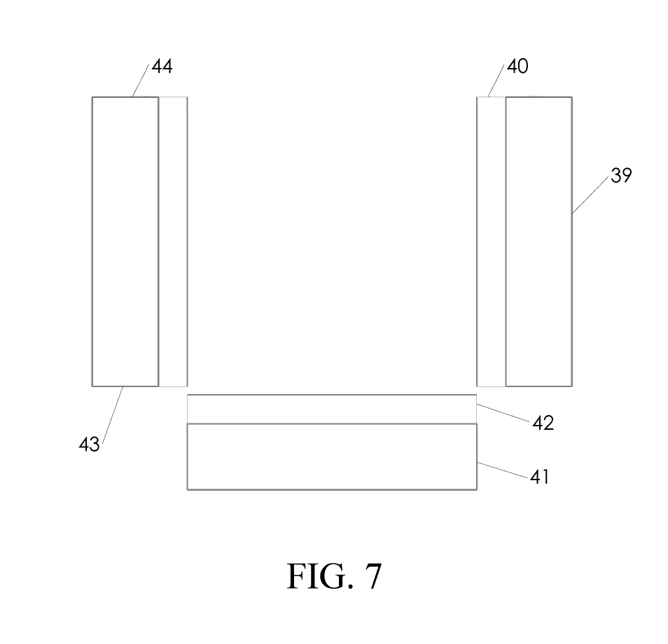

FIG. 7 depicts an enhanced recycling optical cavity, which contains LEDs 43, 41, and 39. A dichroic coating 44, 40 and 42 is on at least one LED 43, 41, and 39. The dichroic coating 44, 40, and 42 may be directly coated on LEDs 43, 41, and 39 or be a separate layer which is adhered or otherwise held within the cavity formed by LEDS 43, 41, and 39. More or less LEDs may be used to form the recycling optical cavity. The function of the dichroic coating 44, 40 and 42 is to selectively pass emission from the associated LED 43, 41, and 39 and reflect the emission from the other LEDs within the cavity. This will enhance the efficiency of the cavity. A preferred embodiment of this invention is the use of this technique to isolate AlInGaP red LEDs from GaN blue and green LEDs. However the use of this technique is also disclosed for all LEDs used within a recycling optical cavity.

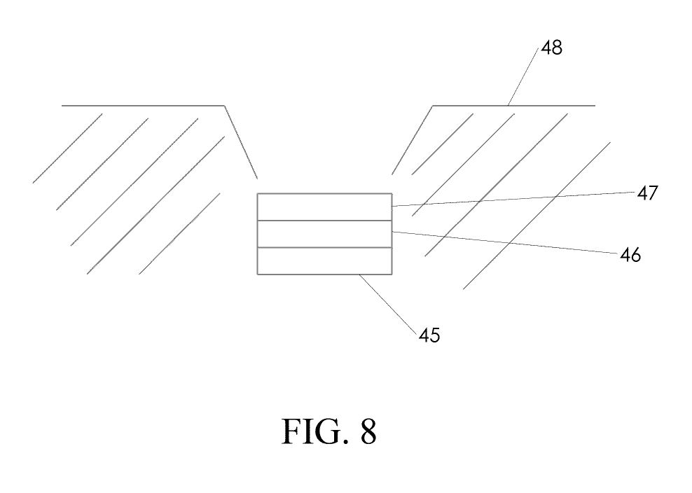

FIG. 8 depicts an enhanced recycling optical cavity is which at least one LED 45, 46, and 47 is stacked together forming a layered emitter rather than just a single emitting layer. The at least one LED 45, 46, and 47 may be mounted within a recycling optical cavity 48 which enhances radiance, creates directivity, recycles polarization, and/or allows for the use of wavelength conversion means as disclosed by the authors in previous filings and are included herein. A preferred embodiment of this invention is the use of freestanding epitaxial LEDs, as disclosed by the authors previously, such that simultaneous, sequential and pulsed operation is possible. Dichroic, polarization, photonic crystals, and sub wavelength structures can enhance device performance as previously disclosed.

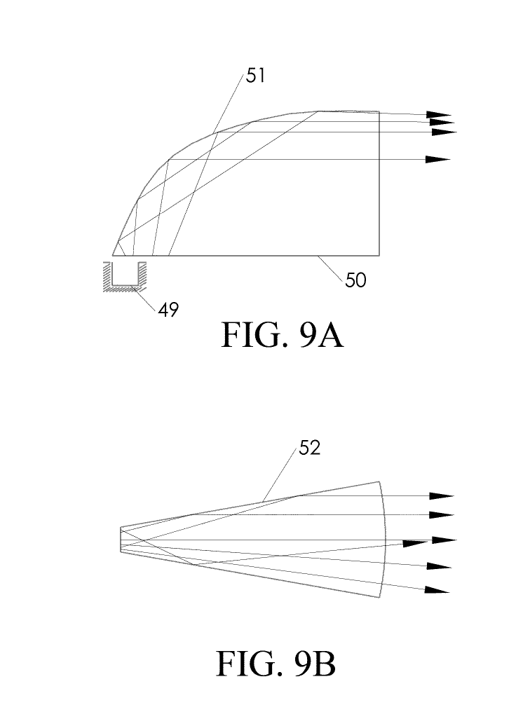

FIG. 9 depicts a ¼ hemisphere lens 50. In this case, a relatively high refractive index material is preferred including sapphire, YAG as well as other transmissive materials. The high refractive index restrict the angular distribution within the ¼ hemisphere lens 50 from the output of light source 49 which may consist of a recycling optical cavity, LED, and/or stacked LEDs. Once the light enters ¼ hemisphere lens, snells law dictates that the angular distribution is restricted. If light source 49 is positioned on the outer periphery of the ¼ hemisphere lens 50, the coupled light with localize along the outer surface 51 of the ¼ hemisphere lens 50. The result is that the output of light source 49 is turned 90 degrees, efficiently mixed and partially collimated. An eye shaped output intensity profile is formed. In addition, the other view of ¼ hemisphere lens 50 shows that the lens may be tapered in the other direction such that the corners of the eye-shaped output intensity profile is folded back on itself forming a substantially rectangular output intensity distribution. While exotic optical surfaces can be used to further enhance this optical element, the need for high refractive index indicates that a preferred embodiment is based on constructing ¼ hemisphere lens 50 from ball lenses, and rod lens which can be economically made. However the use of glass molding techniques is also included.

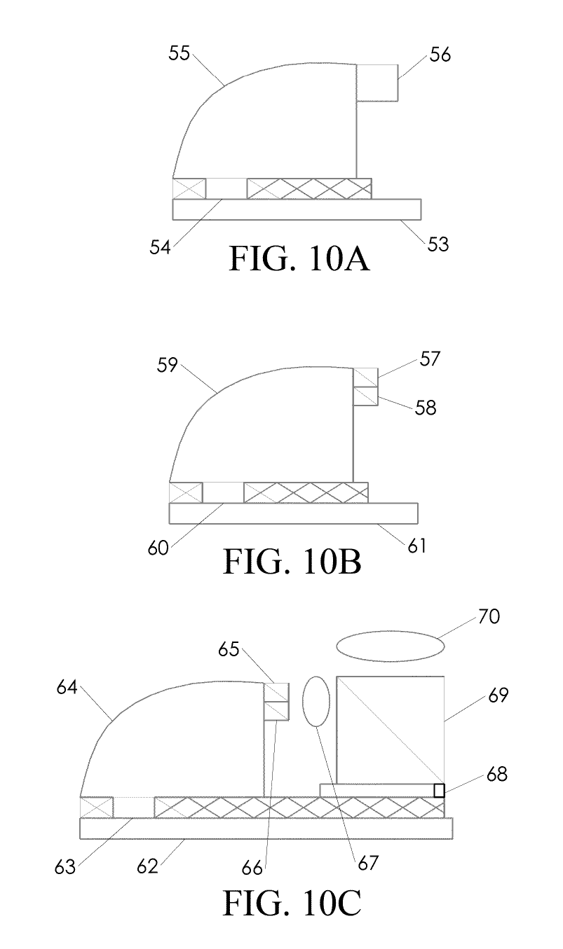

FIG. 10A depicts a compact projector design based on ¼ hemispherical lens 55. The intent of this disclosure is to illustrate how at least one ¼ hemispherical lens can be used to create a microprojector on a single substrate. In FIG. 10A, ¼ hemispherical lens 55 is mounted onto substrate 53, which contains light source 54. Because ¼ hemispherical lens 55 is a solid additional optical element 56 may be attached directly or via a mounting means. In FIG. 10B, ¼ hemispherical lens 59 is again mounted onto a substrate 61, which contains light source 60. In this case, polarization reclaiming optics 57 and 58 are mounted to ¼ hemispherical lens 59. While etendue is doubled, the ability to directly attach polarization reclaiming optics 57 and 58 greatly enhances stability with regard to alignment and shock resistance. In FIG. 10C, ¼ hemispherical lens 64 is mounted on substrate 62, which contains light source 63. Polarization reclaiming optics 65 and 66 are then imaged into polarization beam splitter 69 via relay lens 67. The polarization state of the light source is selected such that polarization beam splitter 69 reflects the incident light down on LCOS 68 which spatially rotates the polarization state such that the desired image is transmitted through polarization beam splitter 69 and images out to viewer via projection optics 70 which maybe refractory or reflective or a combination of both.

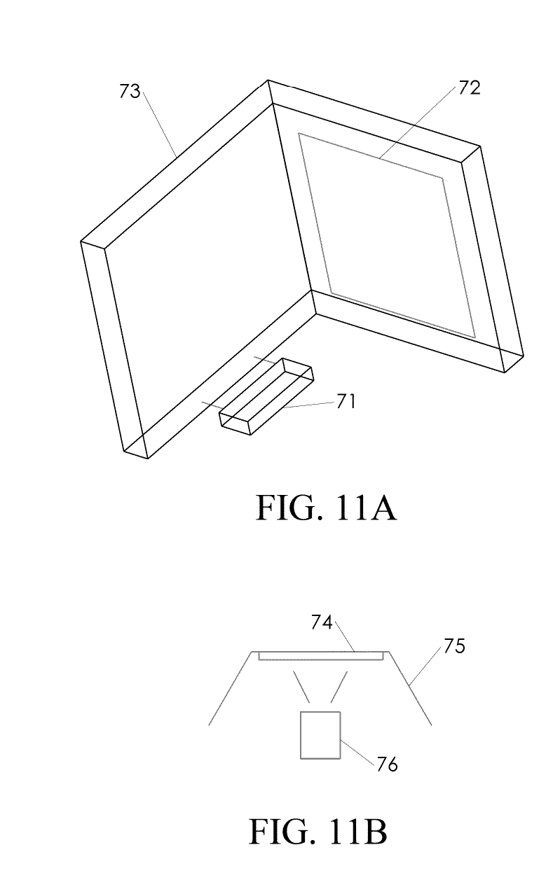

FIG. 11A depicts a bi-fold notebook 73 with integral high contrast screen 72 for use with a microprojector 71. The inclusion of supplemental power, cooling, alignment devices, keyboard, camera, and memory storage is a preferred embodiment of this invention. In this manner, a low cost, lightweight, functional display for presentations and other applications is possible. FIG. 11B depicts a three sided notebook 75 containing a contrast enhancement screen 74 for privacy viewing of the output of microprojector 76

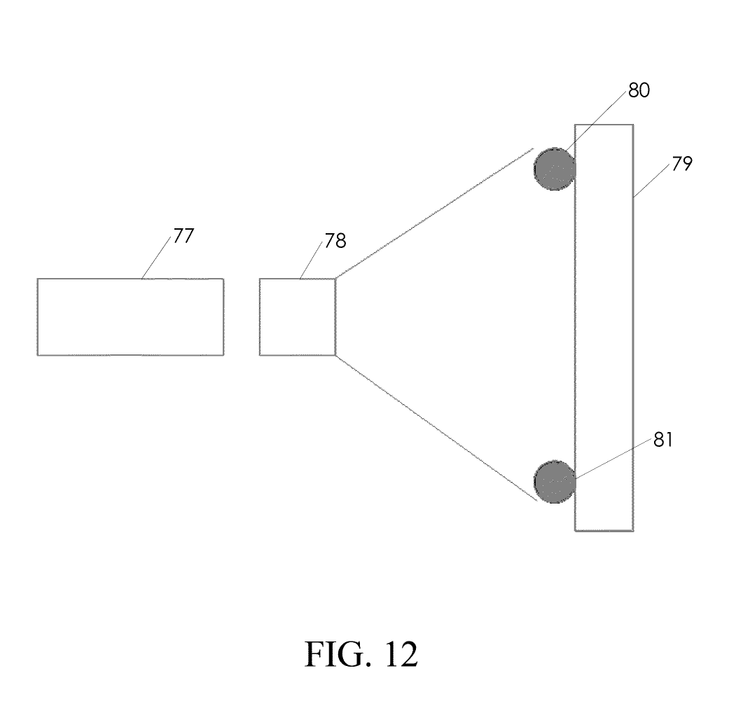

FIG. 12 depicts stabilization optics 78 for microprojector 77. In this case, optical markers 80 and 81 on screen 79 are used to provide feedback to the stabilization optics 78. In this manner, vibrational and other minor motion based differences between microprojector 82 and screen 84 can be compensated for.

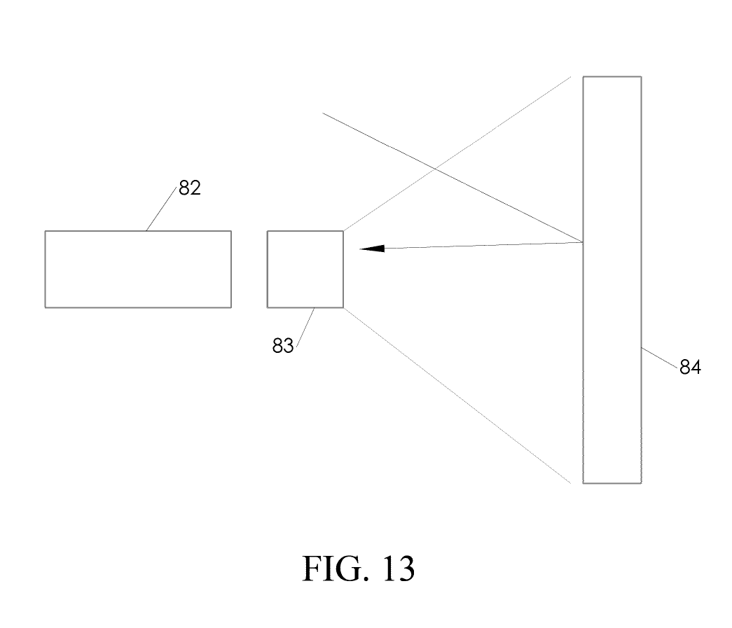

FIG. 13 depicts a microprojector 82 with a CCD sensor 83 integrated into the optical projection light train. CCD sensor 83 is embodied to enable eye movement detection, laser pointer detection 85, as well as white board inputs on screen on or off of screen 84.

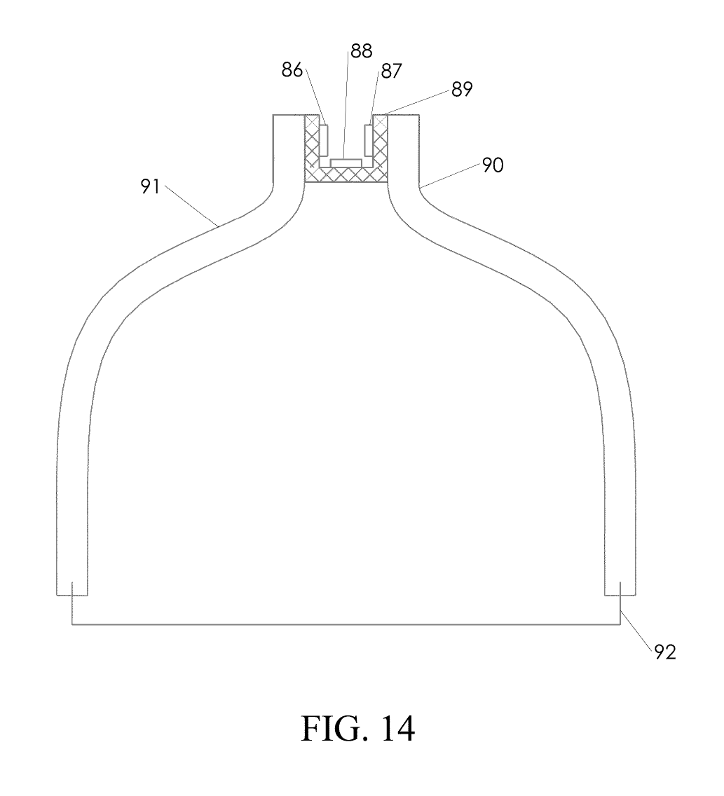

FIG. 14 depicts a cavity 89 containing at least one LEDs 86, 87, and 88 with integrated heatspreading elements 91 and 90. A preferred embodiment of this invention is the use of substantially pyrolytic graphite foils for heatspreading elements 91 and 90. The intent of this disclosure is to provide maximum spreading of the localized heat from at least one LEDs 86,87, and 88 to outer surface of the mobile device in which the cavity 89 is mounted. In this manner a low cost, lightweight cooling means is possible.

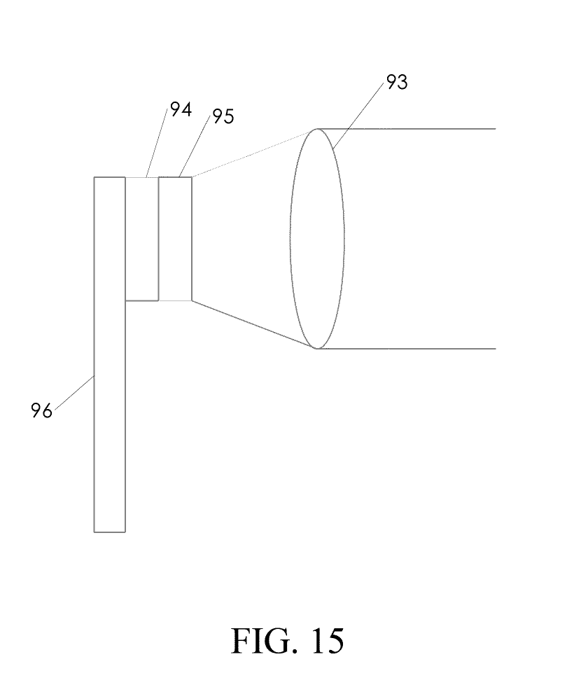

FIG. 15 depicts a freestanding nitride LED array 95 addressed via active matrix 94 attached to heatspreader 96. The output of LED array 95 is coupled out via projection optics 93 which maybe refractive, reflective, and/or combination of both.

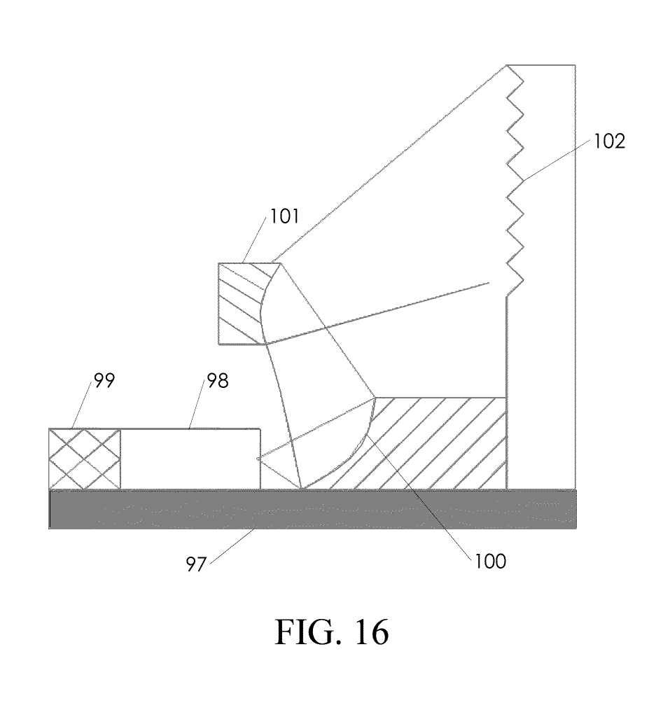

FIG. 16 depicts a microprojector docking station containing supplemental power source 99 to provide additional power to microprojector 98. Integral cooling plate 97 enables additional cooling of microprojector 98. Reflective optics 100 and 101 are used to create a short throw projected images onto contrast enhanced screen 102 as previously disclosed.

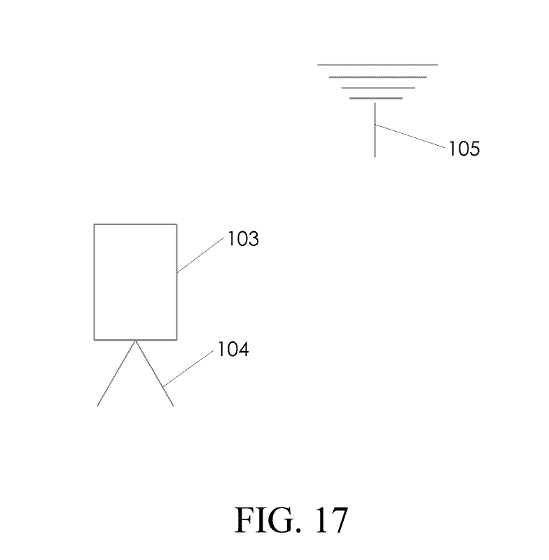

FIG. 17 depicts a microprojector with image output 104 integrated into a keyless entry device 103 which can wirelessly coupled into receiver 105. The use of this device in an automobile provides a single device, which allows access and operation of the vehicle, while also providing a display device for other people within the vehicle. Receiver 105 can also be used to download images to the microprojector as well.

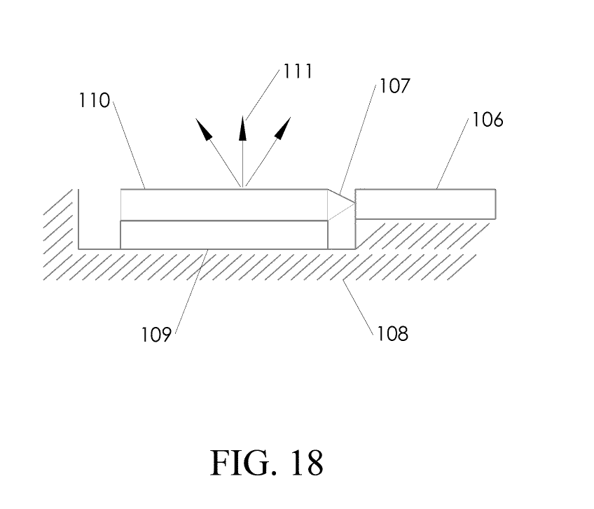

FIG. 18 depicts a combination at least one LED 109 and 110 and laser diode light source 106 for micro projection. In a preferred embodiment at least one LED 109 and 110 are blue and green nitride LEDs and laser diode light source 106 is a red laser diode. The output 107 of laser diode light source 106 is coupled into the edge of the at least one LED 109 and 110 in a manner similar to coupling into a waveguide. Since nitride, in particular is substantially transparent to red light, very efficient waveguiding is possible. The existing extraction elements within at least one LED 109 and 110 will extract red light from the at least one LED 109 and 110 to create output 111. Cooling is via heatsink 108. Even more preferred is the use of freestanding nitride epitaxial LED chips for at least one LED 109 and 110 based on transparency and thickness of the HVPE nitride layers, previously disclosed by the authors. By using the LED as a waveguide for the red or infrared laser diode the problem of absorption within the recycling cavity can be reduced significantly. As stated earlier the Red LEDs in particular absorb blue and green light strongly. The extraction elements used in the blue and green LEDs will also extract the waveguided red light. In this manner a more efficient recycling optical cavity can be produced. In addition, the use of this approach reduces speckle by coupling the laser diode output into a leaky waveguide within the LED layer. The LED layer is a multimode waveguide with surface roughness due to the LED extraction elements. This coupled with mixing in the recycling optical cavity will dramatically reduce speckle.

While the invention has been described in conjunction with specific embodiments and examples, it is evident to those skilled in the art that many alternatives, modifications and variations will be apparent in light of the foregoing description. Accordingly, the invention is intended to embrace all such alternatives, modifications and variations as fall within the spirit and scope of the appended claims.

1. A projector comprising
a recycling LED cavity,
a display element,
a hemispherical ¼ lens, and
at least one reflective optic.

2. A docking station for a cell phone with a microprojector comprising
an image enhancing screen,
a mounting means for said cell phone,
supplemental power,
cooling means, and
memory storage.

3. The docking station for a cell phone with a microprojector of claim 2 with at least one of the following elements; a feedback touch screen, a eye movement detector, a laser pointer, reflective oblique angle imaging element, a cooling plate, a charging element, and an interactive mouse.
